(19) United States
(12) Patent Application Publication
(10) Pub. No.: US 2023/0232754 A1
(43) Pub. Date: Jul. 27, 2023

(54) PLANT GROWTH ADJUSTMENT DEVICE

(71) Applicants: William Schriefer, III, Salisbury, MD (US); Joshua Broad, Salisbury, MD (US)

(72) Inventors: William Schriefer, III, Salisbury, MD (US); Joshua Broad, Salisbury, MD (US)

(21) Appl. No.: 17/585,763

(22) Filed: Jan. 27, 2022

(51) Int. Cl. A01G 9/12

(52) U.S. Cl. CPC A01G 9/12

(57) ABSTRACT

A plant growth adjustment device removably connected to at least a portion of a plant, the plant growth adjustment device including a main body to receive the plant thereon and adjust a shape of the plant, a rear wall perpendicularly disposed away from at least a portion of the main body with respect to a first direction to extend away from the main body, and a plurality of front ridges perpendicularly disposed away from at least a portion of the main body with respect to the first direction to extend away from the main body, such that the rear wall and the plurality of front ridges surround a branch of the plant therebetween.

### BACKGROUND

### 1. Field

The present general inventive concept relates generally to horticulture, and particularly, to a plant growth adjustment device.

### 2. Description of the Related Art

Plant branches, stems, and roots are incredibly fragile, and can be very difficult to alter once a plant has begun growing. Once the plant has expanded its branches in a certain direction, the branches of the plant are highly sensitive to any alteration. In other words, if the plant is not correctly and carefully repositioned, then the likelihood of the plant sustaining some damage is highly likely. In many cases, plant branches grow spontaneously and can take up vast amounts of space, which can drastically alter the desired appearance of an outdoor and/or indoor planting site.

Some known methods to adjust growth of the plant require stakes and/or wires that hold the plant. However, these types of equipment can damage the plant due to lacking any kind of flexibility.

Therefore, there is a need for a plant growth adjustment device that has flexibility and attaches to the plant during early stages of its life to direct growth of the branches, stems, and/or roots.

### SUMMARY

The present general inventive concept provides a plant growth adjustment device.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a plant growth adjustment device removably connected to at least a portion of a plant, the plant growth adjustment device including a main body to receive the plant thereon and adjust a shape of the plant, a rear wall perpendicularly disposed away from at least a portion of the main body with respect to a first direction to extend away from the main body, and a plurality of front ridges perpendicularly disposed away from at least a portion of the main body with respect to the first direction to extend away from the main body, such that the rear wall and the plurality of front ridges surround a branch of the plant therebetween.

The main body may include a plurality of elongated apertures extending from a first edge of the main body to a second edge of the main body to increase a flexibility level of the main body.

The rear wall may include a plurality of rear ridges perpendicularly disposed away from at least a portion of the rear wall with respect to a second direction different from the first direction to at least partially extend toward the plurality of front ridges and cushion the branch in contact thereof.

Each of the plurality of rear ridges may be distanced with respect to each other.

The plurality of rear ridges may be distanced from the plurality of front ridges.

Each of the plurality of front ridges may be distanced with respect to each other.

The main body may be rigid.

The main body may at least partially deforms in response to an application of force thereto.

The main body may have an arcuate shape.

The plurality of front ridges may have an arc size less than an arc size of the rear wall.

The foregoing and/or other features and utilities of the present general inventive concept may also be achieved by providing a plant growth adjustment device removably connected to at least a portion of a plant, the plant growth adjustment device including a main body to receive the plant thereon, the main body including a rear surface disposed on a first side of the main body, and a front surface disposed on a second side of the main body opposite with respect to the first side, and a plurality of ridges perpendicularly disposed away from at least a portion of at least one of the rear surface and the front surface to at least partially extend away from at least one of the rear surface and the front surface.

Each of the plurality of ridges may be disposed away from the rear surface with respect to a first direction, and each of the plurality of ridges are disposed away from the front surface with respect to a second direction different from the first direction.

Each of the plurality of ridges may be distanced with respect to each other.

Each of the plurality of ridges may include a fastener receiving aperture to receive a cord therethrough.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates an isometric top view of a plant growth adjustment device, according to an exemplary embodiment of the present general inventive concept;

FIG. 2 illustrates an isometric top view of a plant growth adjustment device, according to another exemplary embodiment of the present general inventive concept;

FIG. 3A illustrates an isometric top view of a plant growth adjustment device, according to another exemplary embodiment of the present general inventive concept;

FIG. 3B illustrates an isometric top view of the plant growth adjustment device, according to another exemplary embodiment of the present general inventive concept; and

FIG. 4 illustrates a top perspective view of the plant growth adjustment device as disposed on a plant, according to another exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Plant Growth Adjustment Device 100
Main Body 110
Rear Wall 120
Rear Ridges 121
Front Ridges 130
Plant Growth Adjustment Device 200
Main Body 210
Elongated Apertures 211
Rear Wall 220
Rear Ridges 221
Front Ridges 230
Plant Growth Adjustment Device 300
Main Body 310
Rear Surface 311
Front Surface 312
Ridges 320
Fastener Receiving Aperture 321

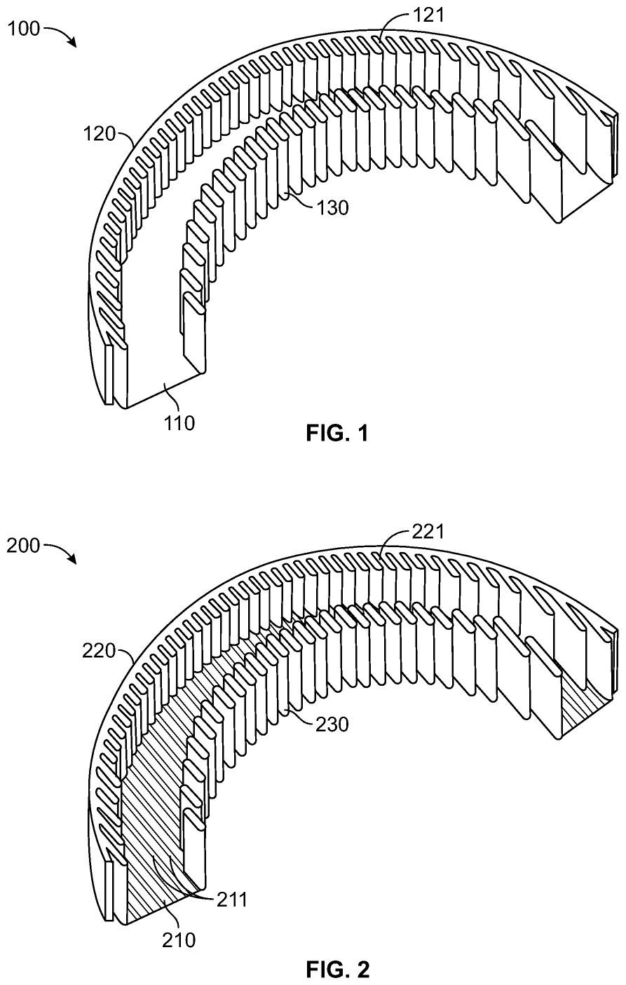

FIG. 1 illustrates an isometric top view of a plant growth adjustment device 100, according to an exemplary embodiment of the present general inventive concept.

The plant growth adjustment device 100 may be constructed from at least one of plastic, metal, wood, and rubber, etc., but is not limited thereto. For example, the plant growth adjustment device 100 may be formed from polylactic acid (PLA) that is a common bioplastic and used in three-dimensional printers.

The plant growth adjustment device 100 may include a main body 110, a rear wall 120, and a plurality of front ridges 130, but is not limited thereto.

Referring to FIG. 1, the main body 110 is illustrated to have an arcuate (i.e., curved) shape. However, the main body 110 may be linear, circular, S-shaped, Z-shaped, or any other shape known to one of ordinary skill in the art, but is not limited thereto.

The main body 110 may be constructed to be rigid and/or solid along at least a portion of a surface thereof. The main body 110 may resist movement. The main body 110 may adjust (e.g., curve) a shape of the plant 10.

The rear wall 120 may be perpendicularly disposed away from at least a portion of a first edge of the main body 110 with respect to a first direction. Moreover, the rear wall 120 may extend away from the main body 110 at a predetermined distance based on a size of a branch 11, a stem, and/or a root of the plant 10. Furthermore, the rear wall 120 may have an arcuate shape similar to the arcuate shape of the main body 110.

The rear wall 120 may include a plurality of rear ridges 121, but is not limited thereto.

Each of the plurality of rear ridges 121 may be perpendicularly disposed away from at least a portion of the rear wall 120 with respect to a second direction different from the first direction. Each of the plurality of rear ridges 121 may at least partially extend toward a front edge of the main body 110. Additionally, the plurality of rear ridges 121 may cushion the branch 11, the stem, and/or the root of the plant 10 in contact thereof.

Furthermore, each of the plurality of rear ridges 121 may be distanced with respect to each other. As such, the plurality of rear ridges 121 may receive a portion of the branch 11, the stem, and/or the root of the plant 10 therebetween.

Each of the plurality of front ridges 130 may be perpendicularly disposed away from at least a portion of a second edge of the main body 110 with respect to the first direction. In other words, the plurality of front ridges 130 may be disposed in parallel with the rear wall 120. Moreover, the plurality of front ridges 130 may extend away from the main body 110 at a predetermined distance based on a size of the branch 11, the stem, and/or the root of the plant 10, such that the plurality of front ridges 130 may have a length similar to a length of the rear wall 120 and/or the plurality of rear ridges 121 from the main body 110 to a distance away from the main body 110. Furthermore, the plurality of front ridges 130 may have an arcuate shape similar to the arcuate shape of the main body 110 and/or the rear wall 120. However, a size of the arc for the plurality of front ridges 130 may be less than a size of the arc for the rear wall 120. The rear wall 120 and/or the plurality of rear ridges 121 may be distanced (e.g., form a space) from the plurality of front ridges 130.

Also, each of the plurality of front ridges 130 may be distanced with respect to each other. As such, the plurality of front ridges 130 may receive a portion of the branch 11, the stem, and/or the root of the plant 10 therebetween.

Referring again to FIG. 1, the main body 110, the rear wall 120, the plurality of rear ridges 121, and/or the plurality of front ridges 130 may receive the branch 11, the stem, and/or the roots of the plant 10 therein and/or therebetween. For example, the branch 11 may be inserted between the space formed between the rear wall 120, the plurality of rear ridges 121, and/or the plurality of front ridges 130. As such, the rear wall 120, the plurality of rear ridges 121, and/or the plurality of front ridges 130 may at least partially deform (i.e., bend, stretch, expand) the branch 11, the stem, and/or the root of the plant 10 based on the shape of the main body 110. Accordingly, the rear wall 120, the plurality of rear ridges 121, and/or the plurality of front ridges 130 may at least partially surround the branch 11.

It is important to note that plant growth adjustment device 100 may be used for a short period of time due to being rigid. Also, any reference to branch 11 may also include the stem and/or the root of the plant 10.

Therefore, the plant growth adjustment device 100 may be removably connected to the plant 10 during early stages of its life to change direction of growth for the branch 10, the stem, and/or the root of the plant 10. Also, the plant growth adjustment device 100 may control a height, a width, and/or a position of the plant 10 while simultaneously providing ultimate protection for the plant 10. Thus, the plant growth adjustment device 100 may eliminate sporadic growth of the plant 10 and facilitate access to direct sunlight, which improves photosynthesis and organic plant growth while preventing damage to the plant 10.

FIG. 2 illustrates an isometric top view of a plant growth adjustment device 200, according to another exemplary embodiment of the present general inventive concept.

The plant growth adjustment device 200 may be constructed from at least one of plastic, metal, wood, and rubber, etc., but is not limited thereto. For example, the plant growth adjustment device 200 may be formed from polylactic acid (PLA) that is a common bioplastic and used in three-dimensional printers.

The plant growth adjustment device 200 may include a main body 210, a rear wall 220, and a plurality of front ridges 230, but is not limited thereto.

The main body 210 may include a plurality of elongated apertures 211, but is not limited thereto.

Referring to FIG. 2, the main body 210 is illustrated to have an arcuate (i.e., curved) shape. However, the main body 210 may be linear, circular, S-shaped, Z-shaped, or any other shape known to one of ordinary skill in the art, but is not limited thereto.

The main body 210 may be constructed to be flexible along at least a portion of a surface thereof. In other words, the main body 210 may at least partially deform (e.g., bend, stretch, expand) in response to an application of force (e.g., pushing, pulling) thereto. The main body 210 may be more flexible with respect to the main body 110. The main body 210 may adjust (e.g., curve) a shape of the plant 10.

The plurality of elongated apertures 211 may be disposed on at least a portion of the main body 210. Moreover, the plurality of elongated apertures may extend from a first edge of the main body 210 to a second edge of the main body 210. As such, the main body 210 may be more pliable and/or flexible. In other words, the plurality of elongated apertures 211 may increase a flexibility level of the main body 210.

The rear wall 220 may be perpendicularly disposed away from at least a portion of the first edge of the main body 210 with respect to a first direction. Moreover, the rear wall 220 may extend away from the main body 210 at a predetermined distance based on a size of a branch 11, a stem, and/or a root of the plant 10. Furthermore, the rear wall 220 may have an arcuate shape similar to the arcuate shape of the main body 210.

The rear wall 220 may include a plurality of rear ridges 221, but is not limited thereto.

Each of the plurality of rear ridges 221 may be perpendicularly disposed away from at least a portion of the rear wall 220 with respect to a second direction different from the first direction. Each of the plurality of rear ridges 221 may at least partially extend toward a front edge of the main body 210. Additionally, the plurality of rear ridges 221 may cushion the branch 11, the stem, and/or the root of the plant 10 in contact thereof.

Furthermore, each of the plurality of rear ridges 221 may be distanced with respect to each other. As such, the plurality of rear ridges 221 may receive a portion of the branch 11, the stem, and/or the root of the plant 10 therebetween.

Each of the plurality of front ridges 230 may be perpendicularly disposed away from at least a portion of the second edge of the main body 210 with respect to the first direction. In other words, the plurality of front ridges 230 may be disposed in parallel with the rear wall 220. Moreover, the plurality of front ridges 230 may extend away from the main body 210 at a predetermined distance based on a size of the branch 11, the stem, and/or the root of the plant 10, such that the plurality of front ridges 230 may have a length similar to a length of the rear wall 220 and/or the plurality of rear ridges 221 from the main body 210 to a distance away from the main body 210. Furthermore, the plurality of front ridges 230 may have an arcuate shape similar to the arcuate shape of the main body 210 and/or the rear wall 220. However, a size of the arc for the plurality of front ridges 230 may be less than a size of the arc for the rear wall 220. The rear wall 220 and/or the plurality of rear ridges 221 may be distanced (e.g., form a space) from the plurality of front ridges 230.

Also, each of the plurality of front ridges 230 may be distanced with respect to each other. As such, the plurality of front ridges 230 may receive a portion of the branch 11, the stem, and/or the root of the plant 10 therebetween.

Referring again to FIG. 2, the main body 210, the rear wall 220, the plurality of rear ridges 221, and/or the plurality of front ridges 230 may receive the branch 11, the stem, and/or the roots of the plant 10 therein and/or therebetween. For example, the branch 11 may be inserted between the space formed between the rear wall 220, the plurality of rear ridges 221, and/or the plurality of front ridges 230. As such, the rear wall 220, the plurality of rear ridges 221, and/or the plurality of front ridges 230 may at least partially deform (i.e., bend, stretch, expand) the branch 11, the stem, and/or the root of the plant 10 based on the shape of the main body 210. Accordingly, the rear wall 220, the plurality of rear ridges 221, and/or the plurality of front ridges 230 may at least partially surround the branch 11.

It is important to note that plant growth adjustment device 200 may be used for a long period of time due to being flexible. In particular the plant growth adjustment device 200 may be connected to the plant 10 for longer time than the plant growth adjustment device 100. Also, any reference to branch 11 may also include the stem and/or the root of the plant 10.

Therefore, the plant growth adjustment device 200 may be removably connected to the plant 10 during early stages of its life to change direction of growth for the branch 10, the stem, and/or the root of the plant 10. Also, the plant growth adjustment device 200 may control a height, a width, and/or a position of the plant 10 while simultaneously providing ultimate protection for the plant 10. Thus, the plant growth adjustment device 200 may eliminate sporadic growth of the plant 10 and facilitate access to direct sunlight, which improves photosynthesis and organic plant growth while preventing damage to the plant 10.

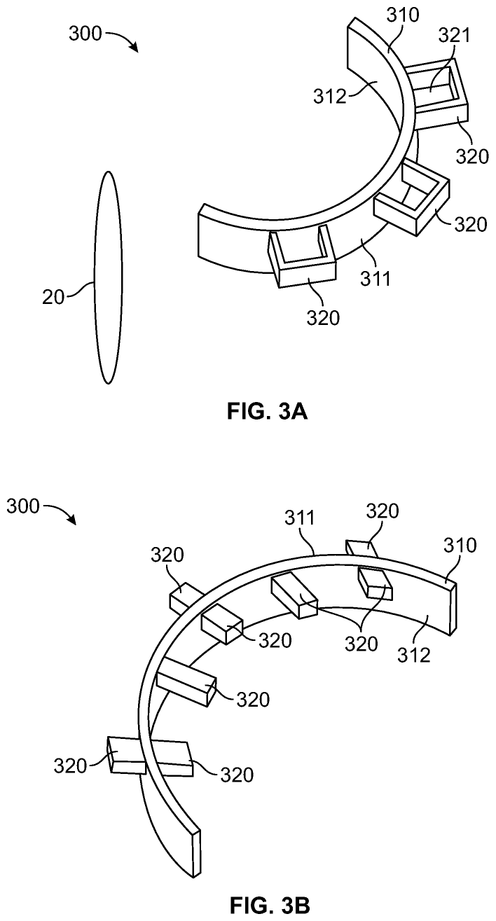

FIG. 3A illustrates an isometric top view of a plant growth adjustment device 300, according to another exemplary embodiment of the present general inventive concept.

FIG. 3B illustrates an isometric top view of the plant growth adjustment device 300, according to another exemplary embodiment of the present general inventive concept.

The plant growth adjustment device 300 may be constructed from at least one of plastic, metal, wood, and rubber, etc., but is not limited thereto. For example, the plant growth adjustment device 300 may be formed from polylactic acid (PLA) that is a common bioplastic and used in three-dimensional printers.

The plant growth adjustment device 300 may include a main body 310 and a plurality of ridges 320, but is not limited thereto.

The main body 310 may include a rear surface 311 and a front surface 312, but is not limited thereto.

Referring to FIGS. 3A and 3B, the main body 310 is illustrated to have an arcuate (i.e., curved) shape. However, the main body 310 may be linear, circular, S-shaped, Z-shaped, or any other shape known to one of ordinary skill in the art, but is not limited thereto.

The main body 310 may be constructed to be rigid and/or flexible along at least a portion of a surface thereof. In other words, the main body 310 may at least partially deform (e.g., bend, stretch, expand) in response to an application of force (e.g., pushing, pulling) thereto. The main body 310 may adjust (e.g., curve) a shape of the plant 10.

The rear surface 311 may be disposed on a first side of the main body 310. The front surface 312 may be disposed on a second side of the main body 310 opposite with respect to the first side. Moreover, the rear surface 311 may be convex, whereas the front surface 312 may be concave. However, the rear surface 311 may be concave and the front surface 312 may be convex.

Each of the plurality of ridges 320 may include a fastener receiving aperture 321, but is not limited thereto.

Each of the plurality of ridges 320 may be perpendicularly disposed away from at least a portion of the rear surface 311 with respect to a first direction. Additionally, each of the plurality of ridges 320 may be perpendicularly disposed away from at least a portion of the front surface 312 with respect to a second direction different from the first direction. Each of the plurality of ridges 320 may at least partially extend away from the rear surface 311 and/or the front surface 312. Additionally, the rear surface 311 and/or the front surface 312 may removably connect to a branch 11, a stem, and/or a root of the plant 10.

Furthermore, each of the plurality of ridges 320 may be distanced with respect to each other. As such, the plurality of ridges 320 may receive a portion of the branch 11, the stem, and/or the root of the plant 10 therebetween.

The fastener receiving aperture 321 may receive a cord 20 (e.g., a rubber band, a string, a rope, a wire, etc.) therethrough. For example, the fastener receiving aperture 321 may receive the cord 20 through a first of the plurality of ridges 320 and/or a second of the plurality of ridges 320 to wrap the cord around the branch 11 and/or the main body 310. Alternatively, the plurality of ridges 320 may receive the cord 20 around any portion thereof to wrap against the branch 11 and/or the main body 310.

As such, the main body 310 and/or the plurality of ridges 320 may at least partially deform (i.e., bend, stretch, expand) the branch 11, the stem, and/or the root of the plant 10 based on the shape of the main body 310.

Therefore, the plant growth adjustment device 300 may be removably connected to the plant 10 during early stages of its life to change direction of growth for the branch 10, the stem, and/or the root of the plant 10. Also, the plant growth adjustment device 300 may control a height, a width, and/or a position of the plant 10 while simultaneously providing ultimate protection for the plant 10. Thus, the plant growth adjustment device 300 may eliminate sporadic growth of the plant 10 and facilitate access to direct sunlight, which improves photosynthesis and organic plant growth while preventing damage to the plant 10.

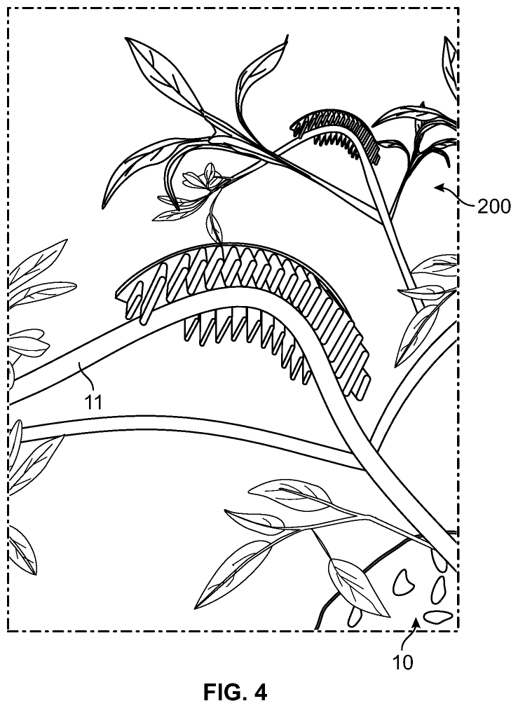

FIG. 4 illustrates a top perspective view of the plant growth adjustment device 200 as disposed on a plant 10, according to another exemplary embodiment of the present general inventive concept.

Referring to FIG. 4, the plant growth adjustment device 200 may be removably connected to at least a portion of the branch 11 of the plant 10. Alternatively, the plant growth adjustment device 100 and/or the plant growth adjustment device 300 may be used.

The present general inventive concept may include a plant growth adjustment device 100 removably connected to at least a portion of a plant 10, the plant growth adjustment device 100 including a main body 110 to receive the plant 10 thereon and adjust a shape of the plant 10, a rear wall 120 perpendicularly disposed away from at least a portion of the main body 110 with respect to a first direction to extend away from the main body 110, and a plurality of front ridges 130 perpendicularly disposed away from at least a portion of the main body 110 with respect to the first direction to extend away from the main body 110, such that the rear wall 120 and the plurality of front ridges 130 surround a branch 11 of the plant 10 therebetween.

The main body 210 may include a plurality of elongated apertures 211 extending from a first edge of the main body 210 to a second edge of the main body 210 to increase a flexibility level of the main body 210.

The rear wall 120 may include a plurality of rear ridges 121 perpendicularly disposed away from at least a portion of the rear wall 120 with respect to a second direction different from the first direction to at least partially extend toward the plurality of front ridges 130 and cushion the branch 11 in contact thereof.

Each of the plurality of rear ridges 121 may be distanced with respect to each other.

The plurality of rear ridges 121 may be distanced from the plurality of front ridges 130.

Each of the plurality of front ridges 130 may be distanced with respect to each other.

The main body 110 may be rigid.

The main body 210 may at least partially deforms in response to an application of force thereto.

The main body 110 may have an arcuate shape.

The plurality of front ridges 130 may have an arc size less than an arc size of the rear wall 120.

The present general inventive concept may also include a plant growth adjustment device 300 removably connected to at least a portion of a plant 10, the plant growth adjustment device 300 including a main body 310 to receive the plant 10 thereon and adjust a shape of the plant 10, the main body 310 including a rear surface 311 disposed on a first side of the main body 310, and a front surface 312 disposed on a second side of the main body 310 opposite with respect to the first side, and a plurality of ridges 320 perpendicularly disposed away from at least a portion of at least one of the rear surface 311 and the front surface 312 to at least partially extend away from at least one of the rear surface 311 and the front surface 312.

Each of the plurality of ridges 320 may be disposed away from the rear surface 311 with respect to a first direction, and each of the plurality of ridges 320 are disposed away from the front surface 312 with respect to a second direction different from the first direction.

Each of the plurality of ridges 320 may be distanced with respect to each other.

Each of the plurality of ridges 320 may include a fastener receiving aperture 321 to receive a cord 20 therethrough.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A plant growth adjustment device removably connected to at least a portion of a plant, the plant growth adjustment device comprising:
a main body to receive the plant thereon and adjust a shape of the plant;
a rear wall perpendicularly disposed away from at least a portion of the main body with respect to a first direction to extend away from the main body; and
a plurality of front ridges perpendicularly disposed away from at least a portion of the main body with respect to the first direction to extend away from the main body, such that the rear wall and the plurality of front ridges surround a branch of the plant therebetween.

2. The plant growth adjustment device of claim 1, wherein the main body comprises:
a plurality of elongated apertures extending from a first edge of the main body to a second edge of the main body to increase a flexibility level of the main body.

3. The plant growth adjustment device of claim 1, wherein the rear wall comprises:
a plurality of rear ridges perpendicularly disposed away from at least a portion of the rear wall with respect to a second direction different from the first direction to at least partially extend toward the plurality of front ridges and cushion the branch in contact thereof.

4. The plant growth adjustment device of claim 3, wherein each of the plurality of rear ridges are distanced with respect to each other.

5. The plant growth adjustment device of claim 3, wherein the plurality of rear ridges are distanced from the plurality of front ridges.

6. The plant growth adjustment device of claim 1, wherein each of the plurality of front ridges are distanced with respect to each other.

7. The plant growth adjustment device of claim 1, wherein the main body is rigid.

8. The plant growth adjustment device of claim 1, wherein the main body at least partially deforms in response to an application of force thereto.

9. The plant growth adjustment device of claim 1, wherein the main body has an arcuate shape.

10. The plant growth adjustment device of claim 1, wherein the plurality of front ridges have an arc size less than an arc size of the rear wall.

11. A plant growth adjustment device removably connected to at least a portion of a plant, the plant growth adjustment device comprising:
a main body to receive the plant thereon and adjust a shape of the plant, the main body comprising:
a rear surface disposed on a first side of the main body, and
a front surface disposed on a second side of the main body opposite with respect to the first side; and
a plurality of ridges perpendicularly disposed away from at least a portion of at least one of the rear surface and the front surface to at least partially extend away from at least one of the rear surface and the front surface.

12. The plant growth adjustment device of claim 11, wherein each of the plurality of ridges are disposed away from the rear surface with respect to a first direction, and each of the plurality of ridges are disposed away from the front surface with respect to a second direction different from the first direction.

13. The plant growth adjustment device of claim 11, wherein each of the plurality of ridges are distanced with respect to each other.

14. The plant growth adjustment device of claim 11, wherein each of the plurality of ridges comprise:
a fastener receiving aperture to receive a cord therethrough.
